(19) United States
(12) Patent Application Publication
(10) Pub. No.: US 2005/0227700 A1
(43) Pub. Date: Oct. 13, 2005

(54) Method and system for conveying wireless connection availability

(75) Inventors: Dustin Kirkland, Austin, TX (US); Bryan Christopher Chagoly, Austin, TX (US); David Bruce Kumhyr, Austin, TX (US); Emily Jane Ratliff, Austin, TX (US)

Correspondence Address: Darcell Walker, Suite 250, 9301 Southwest Freeway, Houston, TX, 77074, US

(73) Assignee: International Business Machines Corporation, Armonk, NY (US)

(21) Appl. No.: 10/821,052

(22) Filed: Apr. 8, 2004

(51) Int. Cl. H04Q 7/20

(52) U.S. Cl. 455/453; 455/422.1

(57) ABSTRACT

The present invention is a method and system that determines the connection availability of a mobile or cellular device to the communication network in the current location of the mobile or cellular device. The system of the present invention comprises a communication tower containing a means to monitor the current connection capacity of the tower. This monitoring process would involve establishing the maximum call connection capability of the tower. This process also maintains a current count of the number of calling devices that are connected through the tower. As the number of connections increases toward the maximum number of connections, the tower will begin to broadcast messages to mobile and cellular telephone devices in the area of the tower the current connection capability to that tower. The mobile or cellular devices would receive the message and display the information to the device user. With this information, the user could decide whether to continue to attempt to call via the tower or to wait to a later time or until the caller is in another area than the current calling tower.

### FIELD OF THE INVENTION

This invention relates to a method and system for determining and conveying telephone connection availability and in particular this invention relates to a method and system for determining and conveying connection availability for a wireless, mobile or cellular telephone device in a particular calling area.

### BACKGROUND OF THE INVENTION

The telephone is one of the main means of communication used today. Throughout the world, the telephone provides people, businesses, governmental agencies and virtually all other entities with the capability to instantly communicate with each other. The telephone has evolved from just a device used for verbal/oral communication to a device that is used to transmit all types of communications including video and text messages. In addition, the actual telephone device has changed over time. Some of the original telephones comprised large bases with rotary dials and large hand held pieces through which a person would talk and listen. Today, the some telephone designs are one-piece modules through which a person dials numbers, talks and listens. In addition, the communication networks that link different telephones together have also changed. Historically, a telephone network comprised a telephone connected to a central switching box/location. These switching locations were connected through a network of cables. Many of these communication cables were large lines that contained many small communication wires that carried the telephone information. Today, telephone communications are much more sophisticated than the conventional telephone networks. The basic telephone network having a telephone connected to a switching box does still exist. However, because of the variety of telephones that are in use, there are also many other communication network configurations that include the basic telephone network and other communication means and device.

One reason for the complex communication network is the use of the many different types telephones and the many applications for these telephones. A main means of telephone communication today is the over air (wireless) communication. This wireless communication is accomplished through the use of a mobile/cellular telephone commonly known as a ‘cell phone’. With this form of communication, there is no physical connection between an individual telephone and a communication switching location. Instead, the telephone is communicates wirelessly with a communication tower that directs the call to the desired location. Today, a typical telephone communication network comprises these communication towers and the conventional switching stations. A person can call a wireless telephone from a conventional telephone. The call will be routed to the conventional switching station. Once it is determined that the called number is a wireless telephone, the call is routed via the telephone network from the switching station to the communication tower for that cellular telephone. The telephone network then routes the call to the identified number of the cellular telephone.

Because conventional analog wireless communication is limited by distance, there are networks of communication towers that route calls coming from and going to cellular telephones. These networks comprise a plurality of communication towers located at various distances from each other. Each tower receives and routes the cellular telephones in that area. Because of the mobility of cellular telephones, there is no set number telephone in a particular area. The number of telephones in the area is dynamic (from minute to minute the number of cellular telephones changes). With the convention networks, the number of telephones in area is stable. As a result, a tower has a limited capacity of calls that the tower can accommodate and connect at any one time. If more call attempts are made in the tower's area than the tower can accommodate, then some of the call attempts will not get connected.

There are many times when a user of a mobile device such as a cellular telephone is well within range of a connection point such as a cell tower. In these cases, the connection signal strength will display a high rating for the signal quality, such as 90 percent. Because of this strong signal indicator, the tendency is to believe that the ability to connect on a call attempt is also high. However, there are situations when call attempts in an area are high and the network is simply out of bandwidth and therefore has no remaining connections to delegate to requesting users. Thus, it will appear to the user that they have a high degree of connectivity to the network, but due to bandwidth limitations, they are not able to obtain a connection.

This situation often occurs when there is an unusually high concentration of users in a particular area. For example, there may be 80,000 fans packed into a football stadium or many thousands of people at an amusement park. The cell tower near the stadium or park is normally accustomed to a much smaller number of users requesting access to the network. Users trying to use their cellular telephone might see a perfect signal displayed on their device, however, they might repeatedly get “Network Busy” error messages, because of the heavy number of calls at that tower at that time. This same problem occurs any time there is a spike in usage near a communication point. These times include sporting events, music festivals, as well as other tourist type events. The problem is exceptionally annoying because the user is lead to believe that they will be able to connect to the network because the signal strength is high, although the availability is not.

There still remains a need for a method and system, which will inform the user of the mobile of the actual network availability prior to that user attempting to connect to the network.

### SUMMARY OF THE INVENTION

It is an objective of the present invention to provide a method and system to convey the connection availability of a wireless and mobile device from a particular communication tower.

It is a second objective of the present invention to monitor the capacity of a communication tower to connect calling attempts from wireless and mobile devices.

It is a third objective of the present invention to periodically broadcast to mobile and wireless devices status messages on the connection availability of the network in which the caller is currently located.

It is fourth objective of the present invention to provide a means on the particular wireless or mobile device that will inform the caller of the connection availability of a wireless/mobile device a communication network area.

The present invention is a method and system that determines the connection availability of a mobile or wireless device to the communication network in the current location of the mobile or cellular device. The system of the present invention comprises a communication tower containing a means to monitor the current connection capacity of the tower. This monitoring process would involve establishing the maximum call connection capability of the tower. This process also maintains a current count of the number of calling devices that are connected through the tower at any one time. As the number of connections increases toward the maximum number of connections, the tower will begin to broadcast messages to mobile and cellular telephone devices the current connection capability through the tower in that area. The mobile or cellular devices would receive the message and display the information to the device user. With this information, the user could decide whether to continue to attempt to call via the tower or to wait until the availability of the tower improves.

The primary steps in the present invention comprise determining the maximum calling capacity of a communication tower, monitoring the calling activity in the area of the tower and broadcasting the calling availability in the area of the tower to mobile device and cellular telephone users in the area of the tower. The maximum calling capacity of the tower involves determining the number of calling requests that the tower can accommodate at any one time. This calling capacity information may be obtained from the basic characteristics of the tower. The calling activity-monitoring step simply keeps a current count of the number of calls that are connected through the tower at any one time. The connection availability-broadcasting step involves sending periodic messages to wireless calling devices in the area of the tower conveying the calling availability through that tower at that time. The present invention can perform this broadcast step when the number of calls connected through that tower reaches a certain number. The message broadcast will continue on a periodic basis while the number of connected calls is in access of a certain through number. As mentioned, by knowing the call connection availability through a tower in a particular area, the wireless calling device user can decide whether or not to attempt a call at that time in the area of that particular tower.

### DESCRIPTION OF THE DRAWINGS

FIG. 1 shows the system configuration for a telephone network that comprises both wireless connections and physical connections.

FIG. 2 shows the information contained on a display screen of a conventional wireless calling device such as a cellular telephone.

FIG. 3 shows the information contained on a display screen for a wireless calling in the present invention.

FIG. 4 is a flow diagram illustrating the basic steps in the method of the present invention.

FIG. 5 is a more detailed flow diagram of the steps in the present invention.

FIG. 6 is a flow diagram of the steps in an alternate embodiment of the present invention.

### DETAILED DESCRIPTION OF THE INVENTION

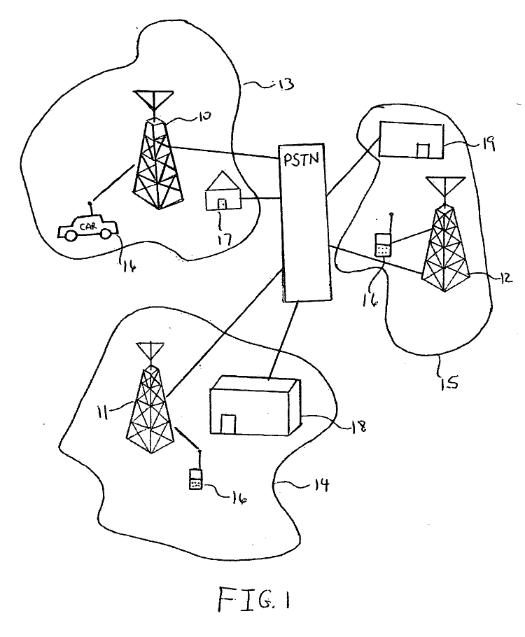

The present invention comprises a method and system for conveying the connection availability of a telephone call attempt using a wireless or mobile device in a particular area and at a particular time. Referring to FIG. 1, shown is telephone communication network incorporating both wireless and physical connection devices. Communication towers 10, 11 and 12 provide the connection means for mobile and wireless devices within this network. Each tower has a defined area in which the tower provides wireless telephone connections. As shown, tower 10 serves area 13, tower 11 serves area 14 and tower 12 serves area 15. Within a defined area, the tower will facilitate the connection of wireless devices to the telephone network. This connection will enable a wireless device 16 to connect to other wireless devices or to conventional and stationary devices such as homes 17, factories 18 and office buildings 19. As shown, stationary devices can connect directly to the PSTN (Public Switched Telephone Network. The towers are also connected to the PSTN. This connection enables the wireless devices and the stationary devices to connect to each other.

The system of the present invention is implemented with the larger communication network shown in FIG. 1. They system of the present invention comprises a wireless telephone communication network that has communication towers such as 10. Each tower has associated software that controls the functioning of the tower. This software receives a call connection attempt, determines the location of the desired number for the connection and makes the call connection.

The system of the present invention incorporates a software module in the communication software that controls the operation of the control tower. This software module of the present invention will monitor the calling activity (including the wireless calls) occurring at the tower. This monitoring process will be on a constant basis. The system of the present also comprises the wireless/mobile device that is used to make the call attempt. Within the wireless device will be a means to inform the user of the calling availability at that time. Current wireless devices display information that indicates signal strength of a call. The present invention will also provide information on the availability to connect a calling attempt. This means to inform the caller can be in the form of an icon on the display screen of the wireless device.

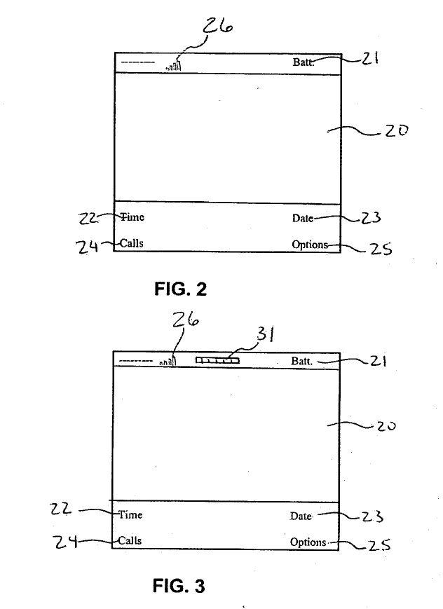

FIG. 2 illustrates a conventional display screen for a wireless calling device. As shown, the device display screen 20 can have information in the form of text data or icons that relay certain standard information. This screen has an icon 21 that conveys the amount of power available in the battery of the device. The current time 22 and the date 23 can be illustrated with text information. Other icons on the display screen, such as calls 24 and options 25, function in a manner similar to the desktop of a computer screen. These icons enable the user to access other options and data on other screen displays within the device. The screen also shows a signal strength icon 26, that indicates to the caller, the current strength of the transmitted signal.

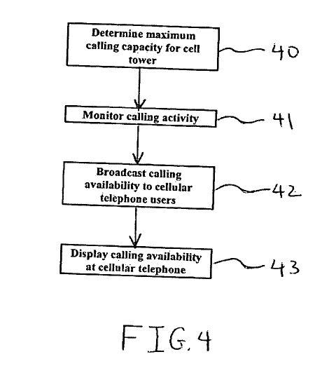

FIG. 3 illustrates the wireless device display screen of FIG. 2 containing the calling connection availability information of the present invention. This information can be displayed in the form of an icon 31. In the alternative, the information can be accessed and displayed via a menu through which a caller can navigate. The information will give the caller an idea of the possibility of successfully making a connection at the present time.

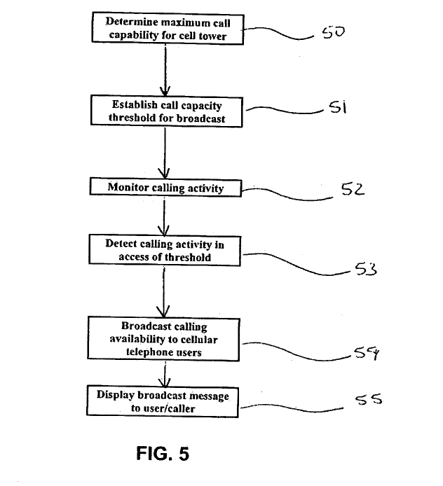

FIG. 4 is a flow diagram illustrating the basic steps in the method of the present invention. As shown, step 40 determines the maximum calling capacity for a cellular telephone tower. This maximum capacity in many instances is a known number. Each tower has the capability to connect to a limited number of telephone lines at any one point in time. This maximum capacity number can be used as the threshold number to determine caller connection capabilities. In step 41, the method of the present invention monitors this maximum capacity number. As the tower connects the calls, a count of the current number of connected calls is kept. This number will constantly change as calls are connected and disconnected via the tower. During peak times, the number of calling attempts increases. As a result, the number of calls connected via the tower also increases. When the number of connected calls reaches the maximum capacity or a predetermined number for that tower, step 42 will broadcast a message to the mobile device users informing them of the connection capability through that tower. The message will appear on the mobile device of the caller in step 43. The message can be broadcast periodically during the period that the calling level remains above the established threshold. As mentioned, once a caller receives this message, the caller has the option attempt to connect via that tower at that time or to wait to another time or maybe use another tower when the caller is in a different geographic area. In an alternative implementation of step 42, there can be a periodic broadcast of the connection availability at a predetermined time interval. This broadcast can occur regardless of whether the connection availability has reached the maximum capacity of the tower.

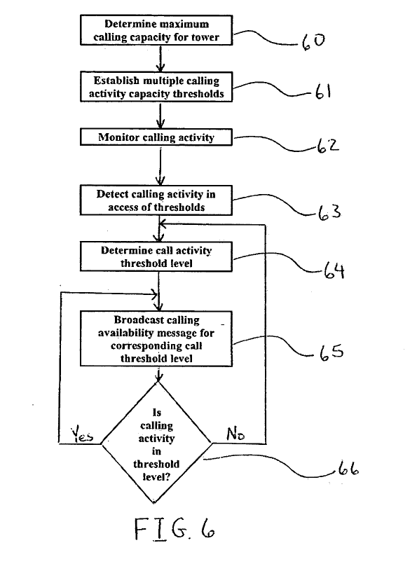

FIG. 5 illustrates a more detailed flow diagram of the steps in the method of the present invention. As with FIG. 4, in step 50 there is a determination of the maximum capacity calls that can be connected through a tower at any point in time. Step 51 establishes a capacity threshold for broadcasting a connection availability message. In this step, as previously mentioned, the threshold for broadcast of a connection availability message can be an arbitrary number that is less than the maximum capacity of the tower. For example, when the calling capacity of the tower reaches or exceeds a threshold of 85 percent, a broadcast message could be sent at that time. Step 52 would again monitor the calling activity of the tower. As with the method described in FIG. 4, this monitoring step can involve maintaining an accurate and current count of the calls connected via the tower. When the number of connected calls reaches or exceeds the established threshold number, step 53 broadcasts a connection availability message to the mobile device users in the area of the tower. Step 54 detects and receives this message at the mobile devices. Software incorporated into the mobile device then displays this connection availability to the user in step 55.

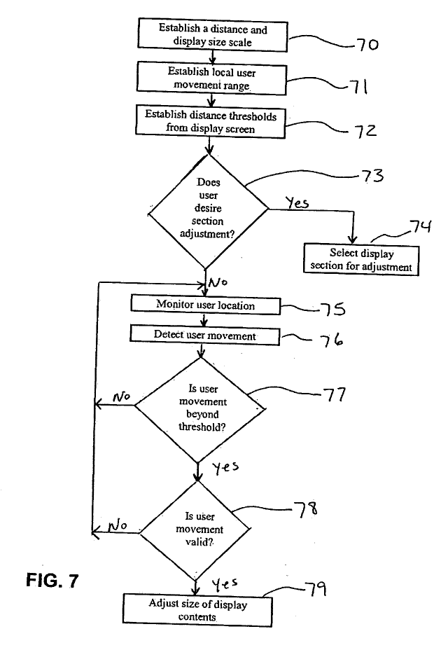

FIG. 6 illustrates the steps in another alternate embodiment of the present invention. In this embodiment, there can be multiple calling threshold levels. In addition, there can be multiple connection availability messages that are broadcast which correspond to the multiple threshold levels. Step 60 determines the maximum call connection capability of the tower. Step 61 will establish multiple calling connection capacity threshold levels. The number of threshold levels can be vary and can be at the discretion of the designer of the process. In an example, there can threshold levels established at 90, 95 and 100 percent of the connection capability of the tower. After the establishment of the threshold levels, step 62 monitors the calling and connection activity of the tower. As with the other embodiments, this step can involve maintaining a current count of the number of calls connected via the particular tower. As the number of call connections increases, step 63 will detect when the number of connected calls exceeds an established threshold. Step 64 determines the actual threshold level that the current number of connected calls exceeds. Steps 63 and 64 can be combined into one step that detects and determines when and which calling threshold has been exceeded. Step 65 broadcasts the call connection availability corresponding to the particular exceeded threshold level. The messages for the different levels can vary in frequency of broadcast and in the type of message. The broadcast message when the number of connected calls exceeds the 90 percent threshold may be an icon 31 that appears on the display of the mobile device for a defined time (maybe 15 seconds). This periodic appearance could be in intervals of 2 to 5 minutes. As the number calls increases and exceeds the 95 percent threshold level, the periodic appearance of the icon would increase to intervals of 2 to 3 minutes. When the threshold levels reached approximately 100 percent the appearance of the icon 31 could be every minute for 20 seconds.

The particular broadcast scheme can vary with the telephone service provider. Some providers may prefer a periodic notice/broadcast of connection availability regardless of the tower capacity. Other providers may prefer some broadcast activity when the number of tower connections reaches a defined threshold.

Referring again to FIG. 6, step 66 determines if the calling activity level is remaining within a certain threshold range such as the 90 to 94 percent range of the tower's. When the calling activity remains within this defined range, the process returns to step 65 where the method repeats the calling availability broadcast for that level. When there is a change in the calling availability level for that tower, step 66 determines that there is a new threshold level of the calling activity. The process then returns to step 64 and continues the process. If the calling activity drops below the first threshold level (90 percent), the broadcasting sequencing would cease altogether. As previously mentioned, when the caller receives a broadcast message, the caller/user will have the option of attempting to connect or waiting to a later time to attempt to connect. When the calling activity is high the likelihood of achieving a connection is low, the user/caller can then decide whether or not to attempt a connection at that time.

As described, the present invention provides a method and system to inform a user of a wireless mobile device of the connection capability to a tower in a particular area. The specific broadcast schemes and displays will vary from provider to provider. It is important to note that while the present invention has been described in the context of a fully functioning data processing system, those skilled in the art will appreciate that the processes of the present invention are capable of being distributed in the form of instructions in a computer readable medium and a variety of other forms, regardless of the particular type of medium used to carry out the distribution. Examples of computer readable media include media such as EPROM, ROM, tape, paper, floppy disc, hard disk drive, RAM, and CD-ROMs and transmission-type of media, such as digital and analog communications links.

1. A method for accurately conveying wireless connection availability through a tower in a defined area comprising the steps of:
determining the maximum capacity of the tower;
establishing a threshold capacity of the tower;
monitoring the calling activity through the tower; and
broadcasting a connection availability message to wireless devices in the area of the tower.

2. The method as described in claim 1 further comprising before said broadcasting step, the step of detecting when the calling activity has exceeded the established threshold capacity for that tower.

3. The method as described in claim 1 wherein said monitoring step further comprises maintaining a constant and accurate count of the number of wireless devices that are connected through the tower.

4. The method as described in claim 3 further comprising after said broadcasting step, the steps of receiving and displaying the broadcasted message at a wireless device in the area of the tower.

5. The method as described in claim 4 wherein the display of the broadcasted message is a period event on the wireless device that corresponds to content of the calling availability through that tower.

6. The method as described in claim 3 wherein said threshold establishing step further comprises establishing multiple threshold levels.

7. The method as described in claim 6 further comprising before said broadcasting step, the step of detecting when the calling activity has exceeded an established threshold capacity level for that tower.

8. The method as described in claim 7 further comprising the step of determining the closest threshold level that has been exceeded by the calling activity.

9. The method as described in claim 8 wherein said broadcasting step further comprises broadcasting a calling activity message to wireless device in the area of the tower, the message corresponding to the exceeded threshold level.

10. A system and system for accurately conveying wireless connection availability comprising:
a telephone tower for use in connecting wireless devices;
a software routine within the telephone tower, said software routine capable of maintaining a count of the number of devices that are connected through the tower, detecting when the number of devices connected via the tower exceed a predetermined threshold level and broadcasting a message to wireless devices in the area related to the connection capability through that tower;
a wireless device for use in communicating via the telephone control tower; and
software within the wireless device for receiving and displaying connection availability via the tower.

11. A computer program product in a computer readable medium for accurately conveying wireless connection availability through a tower in a defined area comprising:
instructions for determining the maximum capacity of the tower;
instructions for establishing a threshold capacity of the tower;
instructions for monitoring the calling activity through the tower; and
instructions for broadcasting a connection availability message to wireless devices in the area of the tower.

12. The computer program product as described in claim 11 further comprising before said broadcasting instructions, instructions for detecting when the calling activity has exceeded the established threshold capacity for that tower.

13. The computer program product as described in claim 11 wherein said monitoring instructions further comprise instructions for maintaining a constant and accurate count of the number of wireless devices that are connected through the tower.

14. The computer program product as described in claim 13 further comprising after said broadcasting instructions, instructions for receiving and displaying the broadcasted message at a wireless device in the area of the tower.

15. The computer program product as described in claim 13 wherein said threshold establishing instructions further comprise instructions for establishing multiple threshold levels.

16. The computer program product as described in claim 15 further comprising before said broadcasting instructions, instructions for detecting when the calling activity has exceeded an established threshold capacity level for that tower.

17. The computer program product as described in claim 16 further comprising instructions for determining the closest threshold level that has been exceeded by the calling activity.

18. The computer program product as described in claim 17 wherein said broadcasting instructions further comprise instructions for broadcasting a calling activity message to wireless device in the area of the tower, the message corresponding to the exceeded threshold level.
